(19) United States
(12) Patent Application Publication
(10) Pub. No.: US 2008/0073038 A1
(43) Pub. Date: Mar. 27, 2008

(54) Window covering

(76) Inventor: Li-Ming Cheng, Kaohsiung City (TW)

Correspondence Address: BIRCH STEWART KOLASCH & BIRCH, PO BOX 747, FALLS CHURCH, VA, 22040-0747, US

(21) Appl. No.: 11/525,173

(22) Filed: Sep. 22, 2006

(51) Int. Cl. E06B 9/30

(52) U.S. Cl. 160/168.1 R

(57) ABSTRACT

A window covering includes an upper rail, a lower rail, a cover curtain, a first pull and a second pull cord assembly, and a brake assembly. The upper rail contains a pull cord control means cooperative with the first pull cord assembly to control movement of the cover curtain, a plurality of rollers and a movable plate on the bottom and an opening on one side. The second pull cord assembly has one end threading through the opening and other end winding on the rollers and threading through the bottom of the lower rail and fasten to the movable plate. The brake assembly is located in the opening to anchor the second pull cord assembly. After the cover curtain has been retracted or extended, the movable plate can be moved to a desired elevation through coupling relationship of the second pull cord assembly to facilitate adjusting of indoor lighting condition.

### FIELD OF THE INVENTION

The present invention relates to a window covering and particularly to a window covering that can alter a cover curtain at a desired elevation after retracted and extended.

### BACKGROUND OF THE INVENTION

Refer to FIGS. 1 and 2 for a conventional window covering 10. It includes an upper rail 11 and a lower rail 12 that are spaced from each other in an up and down manner, and a cover curtain 13 located between them. The upper rail 11 contains a pull cord assembly 111, a plurality of rollers 112 and a pull cord control means 113 to retract and extend the pull cord assembly 111 (reference of the pull cord control means 113 can be found in U.S. Pat. No. 6,837,294 B2). Referring to FIG. 3, the upper rail 11 has a plurality of apertures 114 to allow the pull cord assembly 111 to thread through to fasten to the cover curtain 13. Users can hold the lower rail 12 with one hand and control upward retraction and downward extension of the cover curtain 13 through the pull cord assembly 111 and the pull cord control means 113. For the window covering 10 installed on a door or window, the structure set forth above can block sunshine and provide decoration effect.

FIG. 4 illustrates another type of conventional window covering 10a. It also has an upper rail 11a, a lower rail 12a, a cover curtain 13a and a pull cord assembly (not shown in the drawing) and the like. There is a pull cord control means 14 located on the lower rail 12a (reference of the pull cord assembly 14 can be found in U.S. patent application Ser. No. 11/049,729). The pull cord control means 14 also can automatically retract and extend the pull cord assembly to control upward retraction and downward extension of the cover curtain 13a.

However, in practice, on the aforesaid window covering 10, after having been retracted upwards or extended downwards, the cover curtain 13 cannot be moved independently in the longitudinal direction to alter the elevation. As a result, users cannot adjust indoor lighting condition as desired. Its practicality suffers. The window structure with alterable elevation of the cover curtain 13 has been developed on the market (such as the one disclosed in U.S. Pat. No. 6,164,362). But its structure such as the pull cord assembly is complicated. Fabrication cost is high and operation is not stable. There is still room for improvement.

### SUMMARY OF THE INVENTION

The primary object of the present invention is to provide a window covering that allows a retracted or extended cover curtain to be moved longitudinally to a desired elevation so that users can control the elevation of the cover curtain as desired to adjust indoor lighting condition.

To achieve the foregoing object, the window covering according to the invention mainly includes an upper rail, a lower rail, a cover curtain, a first pull cord assembly, a second pull cord assembly and a brake assembly. The upper rail contains a pull cord control means, a plurality of rollers and a plurality of apertures. The bottom of the upper rail has a movable plate with a hole formed thereon. The lower rail is spaced from the upper rail at a lower side. The cover curtain has an upper end and a lower end fastened respectively to the movable plate and the lower rail. The first pull cord assembly has one end fastened to the pull cord control means and other end winding on the rollers and threading through the apertures of the movable plate and the holes in the cover curtain to fasten to the bottom of the lower rail. The upper rail further has an opening on another side opposing the pull cord control means. The second pull cord assembly has one end threading through the opening and other end winding on the rollers and threading through the apertures and fasten to the movable plate. The brake assembly is located in the opening to brake and anchor the second pull cord assembly.

The structure set forth above can achieve the following functions: after users have retracted the cover curtain upwards or extended the cover curtain downwards through the first pull cord assembly and the pull cord control means, they can move the movable plate upwards or downwards for a selected distance through the second pull cord assembly and the movable plate that are simply constructed and coupled together. After the movable plate has been moved to a desired elevation, it can be anchored through the brake assembly. Thereby the elevation of the cover curtain can be altered as desired, and indoor lighting condition can be adjusted and practicality improves.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a front view of a conventional window covering.

FIG. 2 is a top view of a conventional window covering.

FIG. 3 is another top view of a conventional window covering.

FIG. 4 is a perspective view of another conventional window covering.

FIG. 5 is a front view of the present invention.

FIG. 6 is a top view of the present invention.

FIG. 7 is another top view of the present invention.

FIG. 8 is a schematic view of the second pull cord assembly of the present invention.

FIG. 9 is a schematic view of the present invention in a use condition.

FIG. 10 is a schematic view of the present invention in another use condition.

FIG. 11 is a fragmentary schematic view of another embodiment of the present invention.

FIG. 12 is another schematic view of another embodiment of the present invention.

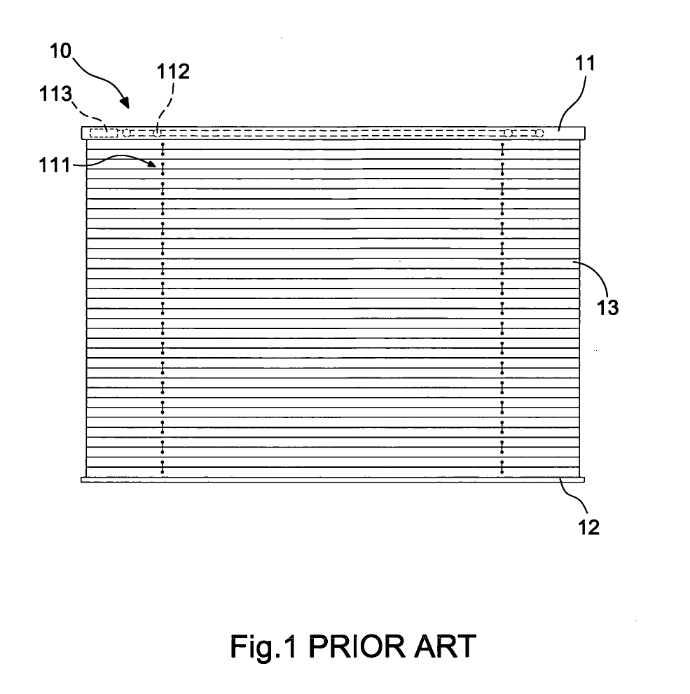

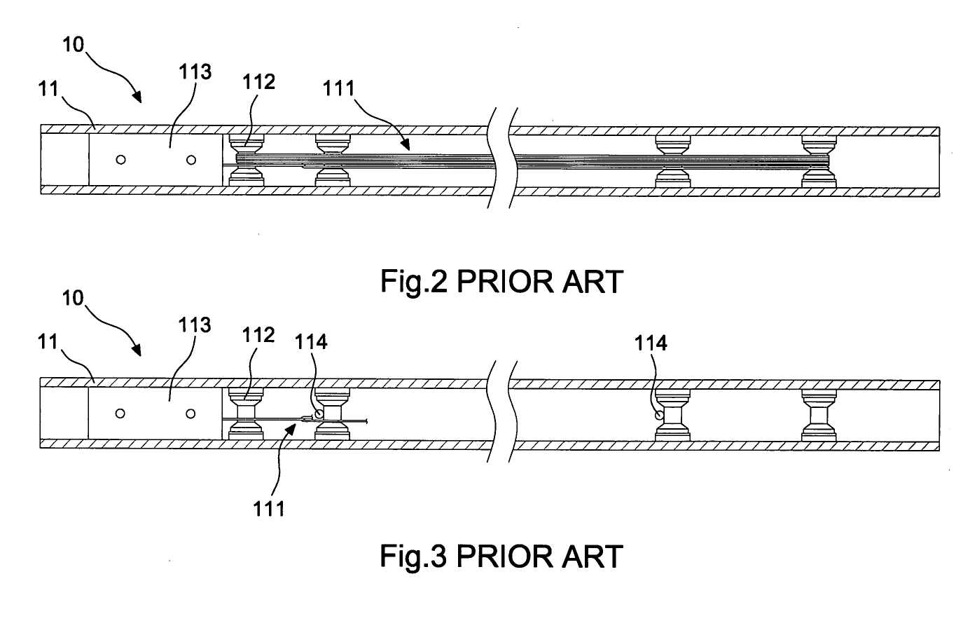

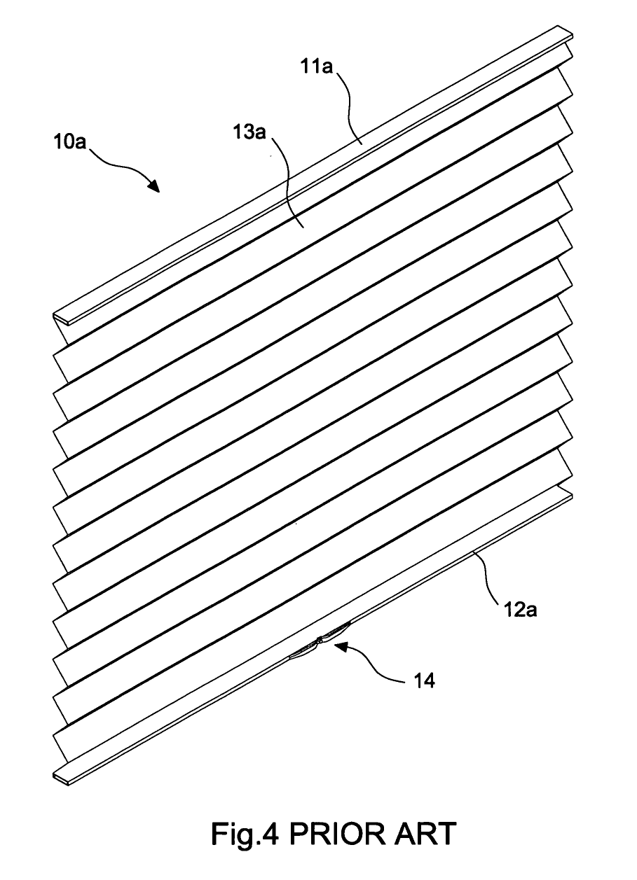

### DETAILED DESCRIPTION OF THE PREFERRED EMBODIMENTS

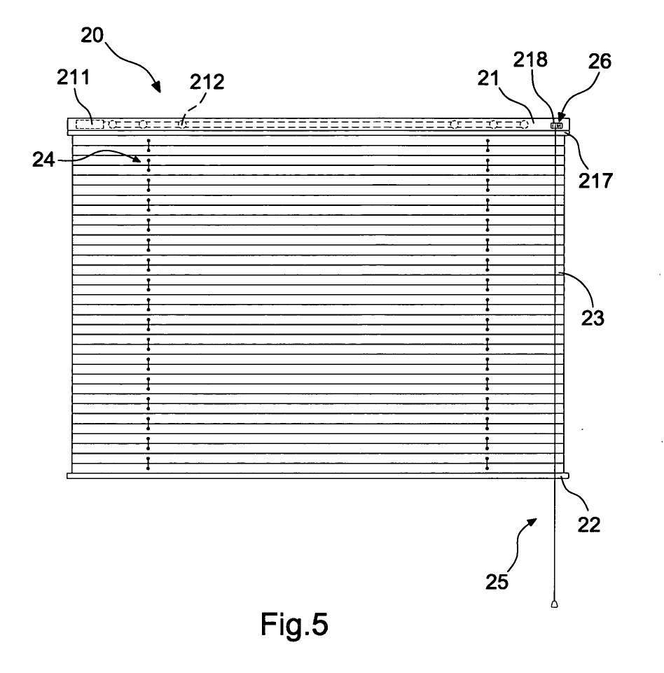

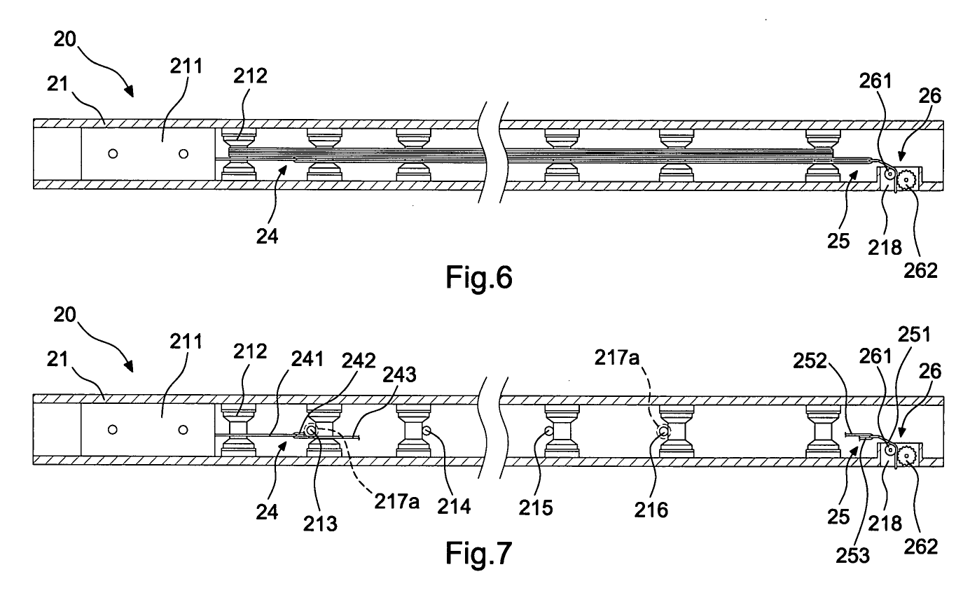

Please refer to FIGS. 5, 6 and 7, the window covering 20 according to the invention mainly includes an upper rail 21, a lower rail 22, a cover curtain 23, a first pull cord assembly 24, a second pull cord assembly 25 and a brake assembly 26. The upper rail 21 contains a pull cord control means 211 to retract and extend the first pull cord assembly 24. It also has a plurality of apertures that include a first aperture 213, a second aperture 214, a third aperture 215 and a fourth aperture 216. There is a movable plate 217 located on the bottom of the upper rail 21 that has two holes 217a formed thereon corresponding to the first aperture 213 and the fourth aperture 216.

The lower rail 22 is spaced from the upper rail 21 at a lower side. The cover curtain 23 has an upper end and a lower end fastened respectively to the movable plate 217 and the lower rail 22. The first pull cord assembly 24 has one end fastened to the pull cord control means 211 and other end winding on the rollers 212 and threading through the first and fourth apertures 213 and 216, and the holes 217a of the movable plate 217 and fastened to the lower rail 22. As an embodiment shown in FIG. 7, the first pull cord assembly 24 includes a primary line 241 and two secondary lines 242 and 243. The primary line 241 has one end fastened to the pull cord control means 211 and other end fastened to the two secondary lines 242 and 243. The primary line 241 has one end fastened to the pull cord control means 211 and other end fastened to the two secondary lines 242 and 243. The two secondary lines 242 and 243 wind on the rollers 212 and thread respectively through the first and fourth apertures 213 and 216 and the holes 217a of the movable plate 217, then are fastened to the lower rail 22. By means of such a structure, the first pull cord assembly 24 and the pull cord control means 211 can control upward retraction and downward extension of the cover curtain 23.

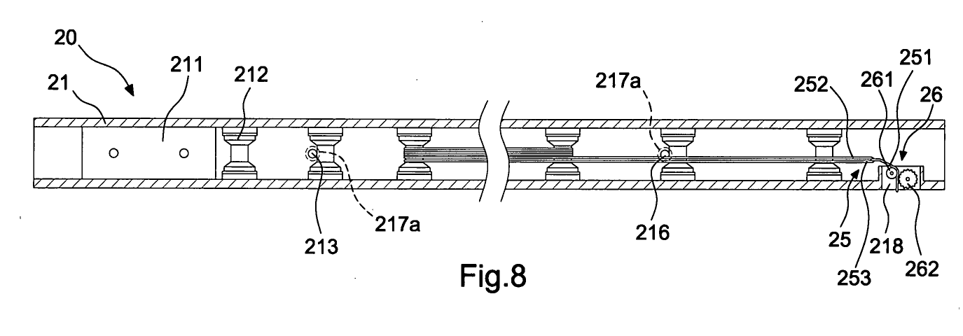

Also referring to FIG. 8 (which shows only the second pull cord assembly 25), the upper rail 21 further has an opening 218 on another side opposing the pull cord control means 211. The second pull cord assembly 25 has one end threading through the opening 218 and other end winding on a selected roller 212 and threading through the second and third apertures 214 and 215, then fastened to the movable plate 217. The brake assembly 26 is located in the opening 218 to brake and anchor the second pull cord assembly 25. The brake assembly 26 includes an auxiliary roller 261 and a brake gear 262 to brake and anchor the second pull cord assembly 25. In the embodiment shown in FIG. 7 the second pull cord assembly 25 includes another primary line 251 and another two secondary lines 252 and 253. The primary line 251 has one end threading through the opening 218 and other end fastened to the two secondary lines 252 and 253. The two secondary lines 252 and 253 wind on the rollers 212 and thread respectively through the second and third apertures 214 and 215, then fasten to the movable plate 217. Thereby the second pull cord assembly 25 enables users to steadily control moving up and down of the movable plate 217.

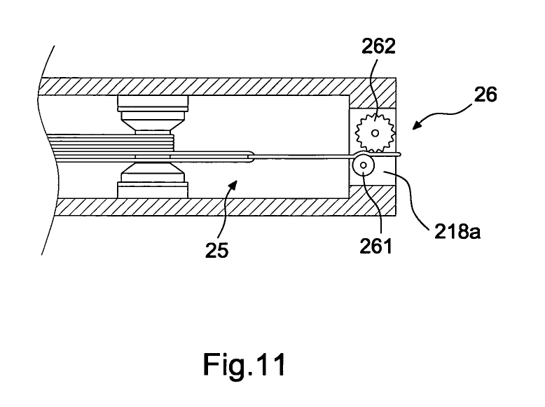

Referring to FIG. 8, the opening 218 of the upper rail 21 may be located on a front side of another end of the upper rail 21 to hold the brake assembly 26. Or as shown in FIG. 11, another end of the upper rail 21 may be closed, and the opening 218a may be formed on the surface of another end of the upper rail 21 to hold the brake assembly 26.

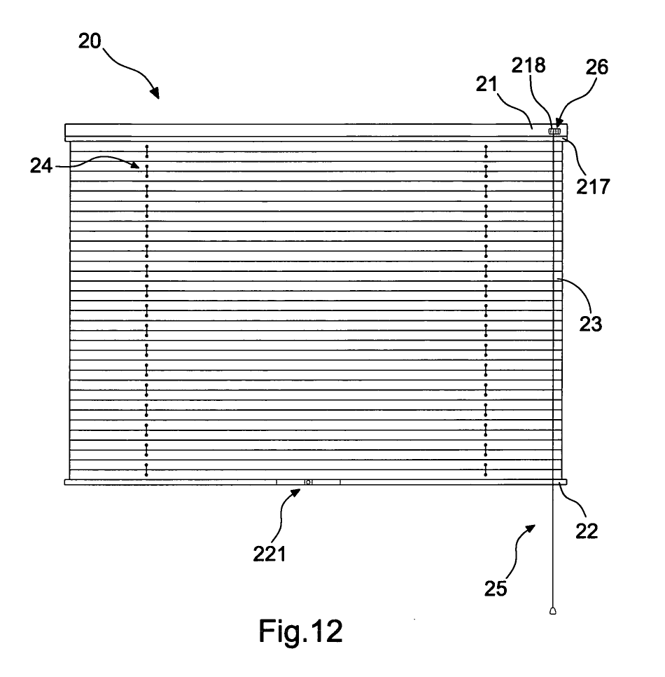

Referring to FIG. 12, the lower rail 22 may also contain another pull cord control means 221 (as taught in U.S. patent application Ser. No. 11/049,729) to retract and extend the first pull cord assembly 24. Thereby it can replace the pull cord control means 211 on the upper rail 21 previously discussed and provide users another operation method to control upward retraction and downward extension of the cover curtain 23.

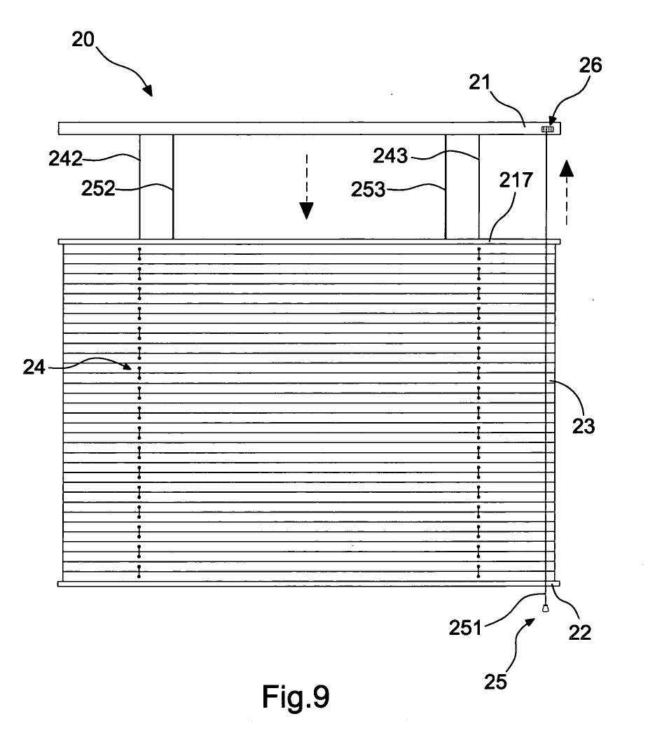

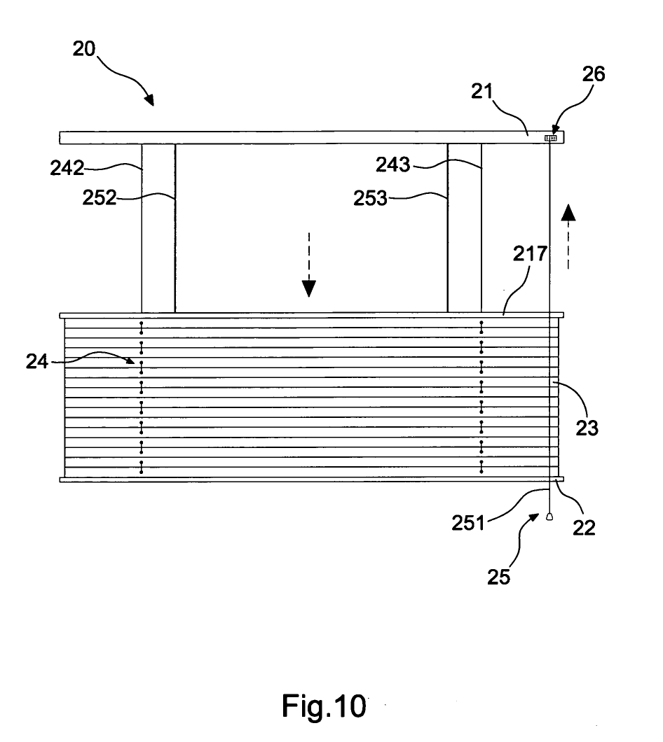

As shown in the drawings depicted above, when the window covering 20 of the invention is in use, the cover curtain 23 can be retracted upwards and extended downwards through the first pull cord 24 and the pull cord control means 211 to block sunshine and provide decoration effect for the door or window where the window covering 20 is installed. Referring to FIGS. 9 and 10, after the cover curtain 23 has been retracted upwards or extended downwards at a selected position, pull the primary line 251 of the second pull cord assembly 25; with the aid of the rollers 212 and coupling relationship of the second pull cord assembly 25 and the movable plate 217, the movable plate 217 can be moved upwards or downwards for a selected distance. After the movable plate 217 is moved to a selected elevation, the second pull cord assembly 25 can be braked through the brake assembly 26 to anchor the movable plate 217. Thereby after the fabric shad 23 has been retracted upwards or extended downwards, the cover curtain 23 still can be moved longitudinally to a desired elevation.

In short, the window covering 20 of the invention, in addition to providing the basic function of upward retraction and downward extension of the cover curtain 23, also allows the cover curtain 23 to be altered at a desired elevation through the movable plate 217, the second pull cord assembly 25 and the brake assembly 26 to enable users to adjust indoor lighting condition as desired. It enhances practicality. Moreover, the second pull cord assembly 25 is simply structured and easy to fabricate and assemble. It is more economic effective.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A window covering, comprising at least:
an upper rail which has a pull cord control means, a plurality of rollers, a bottom having a plurality of apertures formed thereon, a movable plate located on the bottom that has a hole, and an opening formed on one side opposing the pull cord control means;
a lower rail spaced from the upper rail at a lower side;
a cover curtain having an upper end fastened to the movable plate and a lower end fastened to the lower rail;
a first pull cord assembly which is located in the upper rail and has one end fastened to the pull cord control means and other end winding on the rollers and threading through the apertures of the upper rail and the hole of the movable plate and fastened to the lower rail;
a second pull cord assembly which is located in the upper rail and has one end threading through the opening of the upper rail and other end winding on the rollers and threading through the apertures of the upper rail and fastened to the movable plate; and
a brake assembly located in the opening of the upper rail to brake and anchor the second pull cord assembly.

2. The window covering of claim 1, wherein the apertures of the upper rail include a first aperture, a second aperture, a third aperture and a fourth aperture, the movable plate having two holes corresponding to the first aperture and the fourth aperture, the first pull cord assembly including a primary line and two secondary lines, the primary line having one end fastened to the pull cord control means and other end fastened to the two secondary lines, the two secondary lines winding on the rollers and threading through the first and the fourth apertures and the holes of the movable plate and fastening to the lower rail.

3. The window covering of claim 1, wherein the apertures of the upper rail include a first aperture, a second aperture, a third aperture and a fourth aperture, the second pull cord assembly including a primary line and two secondary lines, the primary line having one end threading through the opening and other end fastening to the two secondary lines, the two secondary lines winding on the rollers and threading respectively through the second aperture and the third aperture and fastening to the movable plate.

4. The window covering of claim 1, wherein the brake assembly includes an auxiliary roller and a brake gear.

5. The window covering of claim 1, wherein the opening is formed on a front side of another end of the upper rail.

6. The window covering of claim 1, wherein the upper rail contains the cord control mean at one lateral end and the opening on the opposite lateral end.

7. A window covering, comprising at least:
an upper rail which has a plurality of rollers, a bottom of the upper rail having a plurality of apertures formed thereon, a movable plate located on the bottom that has a hole, and an opening formed on one side opposing a pull cord control means;
a lower rail which is spaced from the upper rail at a lower side and has a pull cord control means;
a cover curtain having an upper end fastened to the movable plate and a lower end fastened to the lower rail;
a first pull cord assembly fastened to the cover curtain and the pull cord control means to control retraction and extension of the cover curtain;
a second pull cord assembly which is located in the upper rail and has one end threading through the opening of the upper rail and other end winding on the rollers and threading through the opening of the upper rail and fastened to the movable plate; and
a brake assembly located in the opening of the upper rail to brake and anchor the second pull cord assembly.

8. The window covering of claim 7, wherein the brake assembly includes an auxiliary roller and a brake gear.
